(19) United States
(12) Patent Application Publication
(10) Pub. No.: US 2005/0048185 A1
(43) Pub. Date: Mar. 3, 2005

(54) DELIVERY SYSTEMS OF HOMOGENEOUS, THERMOREVERSIBLE LOW VISCOSITY POLYMANNAN GUM FILMS

(75) Inventors: Arthur Ballard, Westport, ME (US); Christopher Sewall, Hope, ME (US); James Modliszewski, Brick, NJ (US); William Blakemore, Topsham, ME (US); Peter Riley, Yardley, PA (US)

Correspondence Address: CONNOLLY BOVE LODGE & HUTZ, LLP, P O BOX 2207, WILMINGTON, DE, 19899, US

(73) Assignee: FMC Corporation, Philadelphia, PA (US)

(21) Appl. No.: 10/824,977

(22) Filed: Apr. 14, 2004

Related U.S. Application Data
(60) Provisional application No. 60/462,758, filed on Apr. 14, 2003.
(60) Provisional application No. 60/462,721, filed on Apr. 14, 2003.
(60) Provisional application No. 60/462,617, filed on Apr. 14, 2003.
(60) Provisional application No. 60/462,785, filed on Apr. 14, 2003.
(60) Provisional application No. 60/462,783, filed on Apr. 14, 2003.
(60) Provisional application No. 60/462,794, filed on Apr. 14, 2003.
(60) Provisional application No. 60/462,792, filed on Apr. 14, 2003.
(60) Provisional application No. 60/462,793, filed on Apr. 14, 2003.

(51) Int. Cl. A23L 1/05

(52) U.S. Cl. 426/573

(57) ABSTRACT

Abstract of the Disclosure

The present invention is directed to a delivery system comprising a homogeneous, thermoreversible gel film, wherein the gel film comprises: (i) a film forming amount of low viscosity polymannan gum, e.g., low viscosity guar gum, and optionally at least one of a plasticizer, a second film former, a bulking agent, and a pH controlling agent; and (ii) an active substance. The present invention is also directed to a process for the manufacture thereof.

### Detailed Description of the Invention

### FIELD OF THE INVENTION

The present invention is directed to a delivery system comprising a homogeneous, thermoreversible gel film, wherein the gel film comprises: (i) a film forming amount of low viscosity polymannan gum, e.g., low viscosity guar gum, and optionally at least one of a plasticizer, a second film former, a bulking agent, and a pH controlling agent; and (ii) an active substance. The present invention is also directed to a process for the manufacture thereof.

### BACKGROUND OF THE INVENTION

Use of delivery systems, for example, for oral care actives in breath and cleansing strips, has increased over recent years. The present invention generally relates to delivery systems comprising a gel film that can be used to contain and deliver a wide variety of active substances.

### SUMMARY OF THE INVENTION

As a first embodiment, the present invention is directed to a delivery system comprising a homogeneous, thermoreversible gel film, wherein the gel film comprises: (i) a film forming amount of low viscosity polymannan gum, e.g., low viscosity guar gum and optionally at least one of a plasticizer, a second film former, a bulking agent, and a pH controlling agent; and (ii) an active substance.

As a second embodiment, the present invention is directed to a process for preparing the homogeneous gel film described immediately above comprising the steps of: (i)heating, hydrating, mixing, solubilizing, and, optionally, de-aerating the low viscosity polymannan gum, e.g., guar gum and optionally at least one of a plasticizer, a second film former, a bulking agent, and a pH controlling agent in an apparatus providing sufficient shear, temperature and residence time to form a homogeneous molten composition, wherein the temperature is at or above the solubilizing temperature of the composition; (ii) adding an effective amount of an active substance either prior to or after formation of the molten composition; and (iii) cooling the molten composition containing the active substance at or below its gelling temperature to form the gel films containing the active substance.

### BRIEF DESCRIPTION OF THE DRAWINGS

Figure 1 is a partially broken away, side elevational view of the fluid mixing apparatus for mixing first and second fluids with steam that can be used in the process of the present invention.

### DETAILED DESCRIPTION OF THE INVENTION

The present invention is directed to delivery systems comprising low viscosity polymannan gums such as low viscosity guar gum. Guar gum has found utility commercially as an emulsifier, stabilizer and thickening agent in a variety of fields. It typically has viscosity ranging from 2 to 8,000 mPas in a 1% aqueous solution at 25 ^{o} C. The inventors have found that a particular type of guar gum, i.e., low viscosity polymannan gum (such as low viscosity guar gum), has utility in making the films of the present invention. A typical viscosity range for the low viscosity polymannan and low viscosity guar gum of the present invention is less than 8,000 mPas, preferably, 2 to 6,000 mPas, more preferably, 2 to 4,000 mPas, more preferably, 2 to 2,000 mPas, more preferably, 2 to 1,000 mPas, more preferably, 2 to 500 mPas, more preferably, 2 to 100, mPas in a 1% aqueous solution at 25 ^{o} C. It is understood that low viscosity guars and polymannans can also be measured at higher solids such as ULV 2 25 which has a viscosity of 25 mPas when measured at 2% solids. Such low viscosity guar gum can be obtained commercially from Indian Gum Industries, Ltd and/or their distributors as EDICOL COL ULV Guars such as ULV 2 25, ULV 25, ULV 50, ULV 100, ULV 200, ULV 500 and ULV 1000. It is understood that combinations of low viscosity polymannan and guar gums of the present invention can also be used in this invention. It is also understood that food grade enzymatically modified guars are in the scope of this invention.

It is noted that, e.g., guar gum is generally considered to be a "non-gelling" hydrocolloid. To the inventors' surprise, the use of low viscosity guar gum has been shown to provide gel films having effective film strength for delivery systems. Here, the benefits on processing, etc. can be realized by using low viscosity polymannan/guar gum.

The low viscosity polymannan/guar gum is used in the present invention in a film forming amount (e.g., an amount that adds film strength to the gel film) which is distinguished from trace amounts of low viscosity polymannan/guar gum that do not add film properties to the film. Thus, for example, in a gel film of the present invention, a film forming amount of low viscosity polymannan/guar gum is an amount that adds film strength to the overall film. Such film forming amounts are generally at least 0.25% by weight of the dry gel film, particularly, 0.5% to 90%, more particularly, 0.5% to 50%, more particularly, 0.25 to 25% by weight of the dry gel film depending on the application.

As used herein, "homogeneous film" defines films that, to the naked eye, are visually uniform and free of defects such as lumps, cracks, particles that are undissolved that should be dissolved, non-uniform distribution of insoluble particles, etc. "Fish eyes" (mixed liquid and solid states) or "gel balls" (non-uniform gel structure) would not meet the definition of "homogeneous" as used herein.

The gel films of the present invention are homogeneous, thermoreversible gel films. They can be cast and used in a wide variety of applications as cast films.

As used herein, "thermoreversible film" defines a film that melts or flows when heated. As used herein, the melting temperature is the temperature or temperature range over which the gel film softens or flows.

As used herein, the phrase "gel films" refer to thin membranes formed of structured hydrocolloid. The gel-forming composition is characterized by a gel temperature, the temperature below which the molten mass of the gel composition must be cooled to form a self-supporting structure. Optionally, a molten mass can be cast hot and allowed to cool, as well as dry to further concentrate the solids (controlled moisture removal) until a gel film is formed by the gel composition. The melt temperature of a thermoreversible gel film is higher than its gel temperature.

The gel film of the present invention includes an active substance. Examples of active substances that may be contained within the gel film is at least one of an oral care agent, a breath freshening agent, a pharmaceutical agent, a nutraceutical agent, a salivary stimulant agent, a vitamin, a mineral, a coloring agent, cosmetic ingredient, agricultural active, a sweetener, a flavorant, a fragrance or a food.

The homogeneous, thermoreversible gel film of the present invention can optionally contain at least one of a plasticizer, a second film former, a bulking agent and a pH controlling agent. The components to be added to the gel film and their amounts can vary depending on the desired use of the low viscosity guar gum gel film.

Examples of such a plasticizer include polyols such as glycerin, sorbitol, maltitol, lactitol, corn starch, fructose, polydextrose, solubilized oil, propylene glycol and polyalkylene glycols such as polyethylene glycol. The amount of the plasticizer can vary depending on the desired use and elasticity of the gel film delivery system. For example, such plasticizers can generally be used in an amount of at least 10%, preferably, at least 20%, more preferably, at least 30% by weight of all the components including water in the dry film depending on the desired elasticity of the delivery system. It is possible that the delivery system contains no plasticizer at all. Examples of the second film former that can be used in the present invention include at least one of a starch, starch derivative, starch hydrozylate, cellulose gum, hydrocolloid, an alkylcellulose ether or a modified alkyl cellulose ether. Examples of the hydrocolloid include natural and synthetic hydrocolloids such as at least one of lambda carrageenans such as kappa carrageenan, kappa-2 carrageenan, iota carrageenan and less than fully modified versions thereof and combinations thereof, polymannan gums having higher viscosities than the low viscosity polymannans of the invention , alginates, propylene glycol alginate, pullulan, gellan (including high and low-acyl gellan), dextran, and pectin. As used herein, kappa-2 carrageenan has a molar ratio of 3:6-anhydrogalactose-2-sulfate (3:6AG-2S) to 3:6-anydroglactose (3:6AG) content of 25 to 50%, iota carrageenan has a molar ratio of 3:6AG-2S to 3:6AG content of 80 to 100% and kappa carrageenan has a molar ratio of 3:6AG-2S to 3:6AG content less than that for kappa-2 carrageenan. For example, kappa carrageenan from Eucheuma cottonii , a commonly known and used seaweed source for kappa carrageenan, has a molar ratio of 3:6AG2S to 3:6AG content of less than about 10%; and iota carrageenan from Eucheuma Spinosum , a commonly known and used seaweed source for iota carrageenan, has a molar ratio of 3:6AG2S to 3:6AG content greater than about 85%. Kappa, kappa-2, and iota carrageenans are different from each other in both structure and functionality. If desired, where iota, kappa or kappa-2 carrageenan is used as the second film former, such carrageenan can have a viscosity of 19 cps or less, more particularly less than 10 cps, at 75 °C in a 0.10 molar sodium chloride solution containing 1.5% of the reduced molecular weight carrageenan by weight of the total weight of the solution. This viscosity test can be performed using a Brookfield LVF (Brookfield Engineering Laboratories, Inc.) viscometer using Spindle #1 at 60 r.p.m. and determining the viscosity after six revolutions. An example of an alkylcellulose ether that can be used in the present invention is hydroxyethylcellulose. Examples of modified alkyl cellulose ethers that can be used in the present invention include hydroxypropylcellulose and hydroxypropylmethylcellulose. When the gel films of the present invention contain second film formers, the low viscosity guar gum can be present in an amount of at least 10%, at least 40%, at least 60% or at least 80% by weight of the total amount of film formers in the dry gel film.

Note that some second film formers, such as carrageenan, can contain cations that can have positive and negative impacts on gelling properties and film strength with the carrageenan. Such beneficial cations include potassium and ammonium. These cations can be present in the carrageenan or added to it from other organic or inorganic sources. These beneficial cations can be present in an amount of less than 20% by dry weight of the carrageenan in the gel film (including water). This amount can be varied depending on the components in the system and desired melt and sealing temperatures.

Other cations, such as calcium (as mentioned above), magnesium, aluminum and chromium can adversely impact carrageenan stability and should be kept to a minimum, such as less than 10%, less than 5%, less than 1% by dry weight of the alginate in the gel film (including water).

Examples of the bulking agent include microcrystalline cellulose, microcrystalline starch, modified and unmodified starch, starch derivatives, inulin, starch hydrozylates, sugar, corn syrup and polydextrose. As used herein and in the claims, the term "modified starch" includes such starches as hydroxypropylated starches, acid-thinned starches, and the like. Examples of modified starches that can be used in the present invention include Pure Cote™ B760, B790, B793, B795, M250 and M180, Pure-Dent™ B890 and Pure-Set™ B965, all available from Grain Processing Corporation of Muscatine, Iowa, and C AraTex™ 75701, available from Cerestar, Inc. Examples of starch hydrozylates include maltodextrin also known as dextrin. Unmodified starches such as potato starch can also contribute to the film strength when combined with the hydrocolloids within the scope of the invention. In general, modified starches are products prepared by the chemical treatment of starches, for example, acid treatment starches, enzyme treatment starches, oxidized starches, cross-bonding starches, and other starch derivatives. It is preferred that the modified starches be derivatized wherein side chains are modified with hydrophilic or hydrophobic groups to thereby form a more complicated structure with a strong interaction between side chains.

The amount of the bulking agent to be used in the present invention is generally in the amount of 0 to 20% by weight of the dry film, but more can be used, if desired, for example, at least 20%, more preferably, at least 30% of the dry film.

Note that starch, starch derivatives and starch hydrozylates can be multifunctional. That is, in addition to being used as bulking agents, they can be used as second film formers. When such are used as bulking agents and second film formers, they are generally used in an amount of at least 10%, preferably, at least 20%, by weight, more preferably, at least 30% by weight of the dry film depending on the use of the delivery system.

Examples of the pH controlling agent to be used in the present invention include inorganic and organic bases. Preferred pH controlling agents include hydroxides, carbonates, citrates and phosphates. The pH controlling agent can be chosen as the source of added beneficial cations such as potassium. For some compositions, the pH controlling agent can be used to improve the stability of the gel film. The amount of the pH controlling agent is generally in the amount 0 to 4 %, preferably, 0 to 2 %, by weight of the dry gel film.

The dry gel films (e.g., 80% solids or higher) of the present invention have been found to have, for example, a break force of at least 250 grams, at least 1,000 grams, at least 1,500 grams, at least 2,500 grams, at least 4,000 grams, at least 5,000 grams, at least 6,000 grams, as determined using a Texture Analyzer TA-108S Mini Film Test Rig. At lower solids, the gel films have been found to have a break force of at least 50 grams, at least 100 grams, at least 200 grams, as determined in a similar manner.

The films of the present invention have been found to have a solids content of at least 50%, at least 60%, at least 70%, at least 80% and at least 90% of all components in the gel film. It is understood that up to 15%, 10%, 5% water may remain strongly associated with the solids in the gel film.

It is possible that the films of the present invention can contain nonthermoreversible gums. However, so as not to adversely impact the homogeneous and thermoreversible nature of the gel films of the present invention, such nonthermoreversible films should be present in an amount of less than 50% by weight of the low viscosity guar gum, preferably, less than 40%, more preferably, less than 30%. Examples of such nonthermoreversible gums include crosslinked and partially crosslinked gums such as calcium set (e.g., crosslinked) pectins or alginates. Calcium reactive alginates and pectins, as well as their less refined forms, are considered thermoreversible gums in the absence of divalent cations. Other non-thermoreversible gums such as tragacanth gum contribute to the thermoreversability of the kappa-2 carrageenan by absorption of water within its structure thereby causing the kappa-2 carrageenan to form a denser, three-dimensional structure, as it is solubilized in less water, providing the same effect as increasing the low viscosity polymannan/guar gum amount without the secondary film formers.

The gel films of the present invention are generally made from a process utilizing an apparatus that enables sufficiently high shear, temperature (above the gelling temperature) and residence time so as to provide a homogeneous molten mass of the composition and formation of the gel upon cooling. This is generally accomplished in the apparatus by heating, hydrating, mixing, solubilizing and optionally de-aerating the composition. Such apparatus include but are not limited to Ross mixers, Stephan processors, conventional jet cookers, extruders and the fluid mixing apparatus as set forth in Figure 3. Ross mixers, Stephan processors, extruders and conventional jet cookers are readily available commercially. Prior to cooling, the molten mass can be fed to at least one of a pump, mixer or devolatilizer. An example of a device that performs any one of such functions is an extruder. Note, as an additional aspect of the invention, the molten mass need not necessarily reach homogeneity in step (i). That is, when an additional apparatus such as a mixer, pump and/or devolatilizer is used, homogeneity of the molten mass can be obtained prior to or after feeding the molten composition into at least one of the mixer, pump and/or devolatilizer provided the molten mass reaches homogeneity prior to gelling. An extruded molten mass can also be directed to a film forming or shaping device (e.g. spreader box) that aids in the uniform casting of a continuous film, or, through a die that allows a direct formation of a film or shaped extrudate from the molten mass delivery equipment. Care must be taken to maintain the molten mass above the initiation of restricted flow/gel structure formation. Insulated and pre-heated (to maintain proper temperatures) transfer hoses may be used to insure molten mass flow until desired gel film formation is initiated. Additional processing methods (such as pre-heating the discharge/plunger-like head as seen in a Ross process system) can force (by pressure) the molten mass through the transfer hoses mentioned above. Additional insulation can help maintain molten mass temperatures through the use of a Teflon disk initially placed upon the molten mass surface immediately after removing the mixing device. Note, as an additional aspect of the invention, the molten mass need not necessarily reach full homogeneity in step (i). That is, when an additional apparatus such as a mixer, pump and/or devolatilizer is used, homogeneity of the molten mass can be obtained prior to or after feeding the molten composition into at least one of the mixer, pump or devolatilizer provided the molten mass reaches homogeneity prior to gelling.

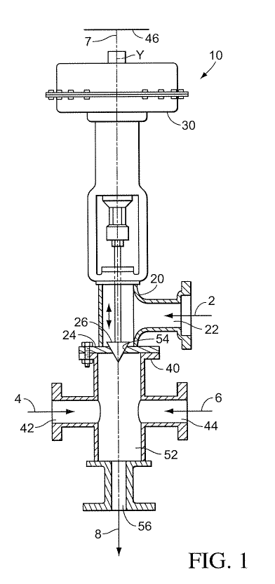

As used herein, a "fluid mixing apparatus" refers to the apparatus in FIG. 1. FIG. 1 illustrates a fluid mixing apparatus 10 . The fluid mixing apparatus 10 is arranged to mix steam 2 with a first fluid or slurry 4 and a second fluid or slurry 6 to produce a molten mass or slurry mixture 8 . The fluid mixing apparatus 10 comprises a first housing 20 having a first inlet 22 through which the steam 2 enters the housing 22 , a nozzle end 24 from which the steam 2 exits the housing 20 , and a nozzle valve or stem 26 disposed at the nozzle end 24 . An actuator means 30 is connected to the first housing 20 for controlling the exit rate or exit pressure of the first fluid 2 at the nozzle end 24 . The actuator means 30 may be of the type manufactured by Fisher Controls U.S.A.

The fluid mixing apparatus 10 further comprises a second, mixing housing 40 coupled to the first housing 20 at the nozzle end 24 of the first housing 20 . The second housing 40 includes a second inlet 42 through which the first fluid 4 enters the second housing 40 , and a third inlet 44 through which the second fluid 6 enters the second housing 40 . The inlets 42 and 44 are disposed downstream of the first inlet 22 . As shown in FIG. 1, the second inlet 42 and third inlet 44 are disposed in a common plane and spaced apart radially from each other, most preferably directly opposite (i.e., 180º apart) about the central axis Y of the mixing apparatus 10 . The second housing 40 defines a generally cylindrical mixing chamber 52 that in turn defines a flow passage extending along the axial length of the mixing chamber 52 from an entry end 54 of the mixing chamber 52 to an exit end 56 of the chamber 52 . The nozzle valve 26 is movable by the actuator 30 between seated and unseated positions at the entry end 54 to control the flow rate of steam 2 into the mixing chamber 52 .

The nozzle end 24 of the first housing 20 directs the steam 2 into the entry end 54 of the mixing chamber 52 . The second inlet 42 and the third inlet 44 radially direct the first fluid 4 and second fluid 6 , respectively, into the mixing chamber 52 . The steam 2 , first fluid 4 and second fluid 6 are mixed in the mixing chamber 52 to form a molten mass or mixture 8 which exits the mixing chamber 52 . The molten mass 8 then may be shaped into a shaped article or formed into a film, such as by casting the mixture 8 onto a cooling drum or by passing the mixture 8 through an extruder.

The fluid mixing apparatus 10 is adapted to produce a mixture for forming a film, more particularly an edible film for making edible delivery systems. Incompatible film components generally are placed in different fluid inlet streams so that such incompatible components come together in the first instance at the interface of the steam injection within the mixing chamber 52 of the fluid mixing apparatus. While FIG. 1 shows inlets for steam, and first and second fluids, one or more additional inlets for one or more additional fluids may be provided. Preferably, the housings 20, 40 and other components of the fluid mixing apparatus 10 are constructed of high-grade stainless steel.

The gel film can also be used to modify the dissolution profile of the dosage forms. For example, gel films of the invention can contain added components that can create solid dosage forms having immediate release, enteric or delayed release capabilities. Definitions of "immediate release", "delayed release" and "enteric" can be found in the U.S. Pharmacopeia and are incorporated herein by reference.

The present invention is now described in more detail by reference to the following examples, but it should be understood that the invention is not construed as being limited thereto. Unless otherwise indicated herein, all parts, percents, ratios and the like are by weight.

### EXAMPLES

Unless otherwise indicated, the following procedures were used to prepare and evaluate the materials and films in Examples 1-3. The Stephan UMC5 processor is a laboratory scale mixing device that provided suitable high shear mixing, heating, and deaerating of the formulations which were cast as films in the laboratory. A suitable batch size used with the Stephan UMC5 processor was 1500 grams.

An aqueous starch dispersion was prepared by dissolving any salts/buffers and pH modifiers in deionized water. The starch and/or maltodextrin (M100) were added and mixed until dissolved/dispersed. Pure Cote® B760 and B790 starches are available from the Grain Processing Corporation of Muscatine, Iowa.

A hydrocolloid mixture was prepared in the Stephan UMC5 processor by premixing the plasticizers until uniform, and adding the preblended dry hydrocolloids portionwise while mixing for about 30 seconds at 200 rpm after each addition. Sorbitol Special and glycerin were used as plasticizers. Sorbitol Special is an aqueous solution of sorbitol and sorbitol anhydrides at 76% solids supplied by SPI Polyols, Inc. (New Castle, DE).

The starch dispersion was added to the non-aqueous hydrocolloid mixture and mixed at 300 rpm for 5 minutes. The mechanical agitation was increased to 2100 rpm and the mixture was heated to 85°C to 95°C with mixing. When the target temperature was achieved, the mixture was stirred for 30 minutes, then the sample was held under vacuum (50-60 bars) with continued agitation for an additional 45 minutes.

When the hold time under vacuum at temperature has been completed, the sample was poured into a preheated wide mouth quart Mason jar. Temperature and pH were recorded. Viscosity was measured on the hot sample using a Brookfield LVF viscometer.

A small portion of the sample was set aside and refrigerated usually overnight prior to measurement of gel/melt properties and solids using an Atago E series hand held refractometer (Gardco, Pompano Beach, FL). The melt temperature was determined by placing a small chunk of the refrigerated gel on a wire string stand held within a test tube so that the chunk does not contact the wall of the test tube. The test tube was covered with aluminum foil with a small hole to allow measurement of the gel temperature using a digital tempermeter probe. The test tube was immersed in the heating bath so that the chunk is below the surface of a hot water bath at approximately 100 ^{o} C. A silicone oil bath was used for samples that had melt temperatures above 90 ^{o} C. The melt temperature was recorded when the gelled sample became wet in appearance, softened and could be stirred (a temperature range was noted). Once the sample had melted, the test tube was transferred to a second beaker containing cold tap water (15 ^{o} C). The temperature probe was used to record the temperature as the sample was cooled and to probe the sample surface to determine whether the sample had begun to gel. The gel temperature was the temperature upon cooling where the sample no longer flowed to fill in an indentation made by the probe.

The hot sample was then cast, using a draw down bar with a gap set at 3mm clearance, onto 177 mm by 177 mm by 5 mm metal plates which were pre-sprayed with PAM (lecithin) to facilitate easy removal of film material. The gel coated plates were covered to avoid loss of moisture from the cast film. Cast films were typically refrigerated (less than 8 ^{o} C) for at least one-half hour prior to removal of the film for testing. Refrigeration is not required for film formation. Dried film strips were prepared by drying the coated plates in a 40 °C forced air/fan oven. Films dried 2 hours at 40 ^{o} C gave an intermediate solids of about 60%, while films dried overnight at 40 ^{o} C typically gave solids of 80% or higher. Test properties were measured at room temperature (approximately 20 °C) unless otherwise specified. The percent of solids of the dried film was determined between the cast film at its formulated solids level and the dried film by difference in weight. Break force (BF) was measured on the cast and dried film strips using a Texture Analyzer TA-108S Mini Film Test Rig.

Unless otherwise indicated, Maltrin M100 was obtained from Grain Processing Corporation, Pure-Cote B760 was obtained from Grain Processing Corporation, Sorbitol Special was obtained from SPI Polyols and Glycerin was obtained from VWR (EP/USP grade).

Example 1

Table II below shows compositions and film properties for formulations prepared using low viscosity guar ULV 50 and low viscosity guar gum in combination with kappa-2 carrageenans.

Cgn A is a kappa-2 carrageenan, a natural random co-polymer of kappa carrageenan and iota carrageenan in a ratio of 1.5 to 3.0:1, respectively, that was obtained as an alkali processed, clarified extract of Gigartina skottsbergii , essentially haploid (gametophyte) plants. Minor levels (under 5% total) of lambda- and theta-carrageenans from diploid (tetrasporophyte) plants were also present. Cgn A has a low divalent cation content and low potassium cation content as shown in Table I.

Cgn B is a kappa-2 carrageenan that was obtained as an alkali processed, clarified extract of a mixture of Gigartina skottsbergii and Sarcothalia crispata , primarily haploid (gametophyte) plants. About 10-20% (total) of lambda- and theta-carrageenans from diploid (tetrasporophyte) plants were also present.

The properties of the kappa-2 carrageenans are shown in Table 1. Viscosity of an aqueous solution at 1.5 wt % solids was measured at 75 ^{o} C using a Brookfield LVF viscometer at appropriate speeds and spindles. The properties of 2% water gels prepared using 2 wt% of samples Cgn A-B (#1) without added cations, (#2) with 0.2 wt% added KCl and (#3) with 0.2% added KCl and 0.2% CaCl ₂ , respectively, were characterized using a TXTM Texture Analyzer. Gels were tested at 25 ^{o} C and the break force (in grams) and the penetration (in millimeters) was recorded.

Table I: Properties of Kappa-2 Carrageenan

| | Cgn A | Cgn B |
|---|---|---|
| Cation Exchange | Yes | No |
| Mg, % | 0.05 | 0.05 |
| Ca, % | 0.15 | 0.45 |
| K, % | 0.67 | 13.40 |
| Na, % | 7.40 | 0.90 |
| Visc, mPs | 98 | NT |
| pH | 10.1 | ″ |
| 2% water gel | 0 | ″ |
| BF (g) | | |
| 2% water gel (KCl) | 38 | ″ |
| BF (g) | | |
| 2% water gel (KCl + CaCl₂₎ | 181 | ″ |
| BF (g) | | |

TABLE II. FORMULATIONS AND FILMS USING GUAR WITH KAPPA-2 CARRAGEENAN

| Ingredients (g) | Ex 1-1 | Ex 1-2 | Ex 1-3 |
|---|---|---|---|
| Water | 836.3 | 836.3 | 836.3 |
| Cgn B | 0.0 | 40.5 | 20.3 |
| Cgn A | 0.0 | 0.0 | 20.3 |
| GUAR ULV 50 | 90.0 | 49.5 | 49.5 |
| Starch B760 | 220.8 | 220.8 | 220.8 |
| POTASSIUM CHLORIDE | 0.0 | 0.0 | 0.0 |
| SORBITOL SP | 264.4 | 264.4 | 264.4 |
| GLYCERIN | 88.2 | 88.2 | 88.2 |
| Total weight (g) | 1500.0 | 1500.0 | 1500.0 |
| Temp, ° C.* | 90 | 90 | 90 |
| VISCOSITY, MPA-S* | >50,000 | >50,000 | >50,000 |
| Gel, ° C. | 47 | 68-69 | 69 |
| Melt, ° C. | 78 | 85-87 | 86-88 |
| pH | 4.8 | 5.8 | 5.9 |
| Cast film | | | |
| Solids, est | 42% | 45% | 42% |
| BF (g) | <40 | 239 | 349 |
| Dried film (2 hr, 40° C.) | | | |
| Solids, est | 65% | 60% | 60% |
| BF (g) | 722 | 953 | 2189 |
| Dried film (16 hr, 40° C.) | | | |
| Solids, est | 86% | 87% | 75% |
| BF (g) | 4436 | 7476 | 6901 |

| | | |
|---|---|---|
| Ingredients (g) | Ex 1-4 | Ex 1-5 |
| Water | 836.3 | 836.3 |
| Cgn B | 0.0 | 0.0 |
| Cgn A | 40.5 | 40.5 |
| GUAR ULV 50 | 49.5 | 49.5 |
| Starch B760 | 220.8 | 220.8 |
| POTASSIUM CHLORIDE | 4.5 | 4.5 |
| SORBITOL SP | 264.4 | 264.4 |
| GLYCERIN | 88.2 | 88.2 |
| Total weight (g) | 1500.0 | 1500.0 |
| Temp, ° C.* | 87 | 95 |
| VISCOSITY, MPA-S* | >50,000 | >50,000 |
| Gel, ° C. | 50 | 54-65 |
| Melt, ° C. | 67-68 | 76-83 |
| pH | 5.2 | 5.2 |
| Cast film | | |
| Solids, est | 40.2% | 45% |
| BF (g) | 130 | 330 |
| Dried film (2 hr, 40° C.) | | |
| Solids, est | 63% | 66% |
| BF (g) | 1194 | 1631 |
| Dried film (16 hr, 40° C.) | | |
| Solids, est | 84% | 84% |
| BF (g) | 6276 | 8733 |

*Temperature and viscosity of the molten mass prior to casting

All films were free of syneresis upon storage and maintained their relative flexibility.

Viscosities were generally found to be at or near the maximum for the test equipment and conditions used. Therefore, use of supplementary equipment with the initial hydration/activation apparatus can provide additional shear and solids concentration effects while maintaining process temperatures well above their high solids set/gel temperatures (>100 ^{o} C.). An example of this supplementary equipment, but not limited to, would be an extruder type device sufficient to maintain adequate temperatures and shear necessary to provide the homogeneous mixing and solids concentrations necessary to allow shaping of the molten mass into a desired form.

Example 2

The properties of films prepared by using blend compositions of low viscosity guar gum ULV50 in combination with either kappa carrageenan or kappa carrageenan and/or iota carrageenan are presented in Tables III and Table IV, respectively. The carrageenans used are described below. Carrageenan L is a kappa carrageenan having a viscosity of 10-15 cP.

Table III: Films Using Low Viscosity Guar and Kappa Carrageenan

| INGREDIENT (G) | Ex 2-1 | Ex 2-2 | Ex 2-3 | Ex 2-4 |
|---|---|---|---|---|
| Water | 836.3 | 836.3 | 836.3 | 836.3 |
| Cgn L | 40.5 | 40.5 | 40.5 | 40.5 |
| Guar ULV 50 | 49.5 | 49.5 | 49.5 | 49.5 |
| Starch B760 | 0 | 220.8 | 220.8 | 0 |
| Starch B790 | 220.8 | 0 | 0 | 0 |
| M-100 | 0 | 0 | 0 | 220.8 |
| KCL | 0 | 0 | 4.5 | 4.5 |
| SORBITOL SP | 264.4 | 264.4 | 264.4 | 264.4 |
| GLYCERIN | 88.2 | 88.2 | 88.2 | 88.2 |
| Total weight | 1500.0 | 1500.0 | 1500.0 | 1500.0 |
| Temp, ° C. | 90 | 90 | 90 | 90 |
| VISCOSITY, MPAS* | 16,000 | >50,000 | 36,750 | 27,100 |
| As Cast | | | | |
| Gel, ° C. | 36 | 53 | 57 | 56 |
| Melt, ° C. | 61 | 75-77 | 76-78 | 75-78 |
| PH | 5.3 | 5.2 | 5.1 | 5.3 |
| Cast film | | | | |
| Solids, est | 41.5% | 40% | 45% | 43% |
| BF (g) | 170 | 227 g | 283 | 217 |
| Dried film (2 hrs @ 40° C.) | | | | |
| Solids, est | 69% | 65% | 64% | 66% |
| BF (g) | 1368 | 1574 | 1144 | 1236 |
| Dried film (16 hours, 40° C.) | | | | |
| Solids, est | 84% | 85% | 85% | 83% |
| BF (g) | 5541 | 7638 | 7029 | 5671 |

* Temperature and viscosity of the molten mass prior to casting

Use of kappa carrageenan in combination with guar (Example 2-2) increased the film strength for guar alone (Example 1-1).

KCl addition (Example 2-3) increased the gel temperature and also the 40% solids gel strength. Further, KCl addition and varying ratios of film forming ingredients will control cast film strength and gel melt temperatures. When kappa carrageenans are used in combination with low viscosity guar of the invention, control of cation divalency desirably prevents/minimizes gel hardening and brittleness.

Table IV reports the compositions and properties of films formed using low viscosity guar ULV50 with kappa and iota carrageenans. Cgn C is an alkali processed clarified kappa carrageenan extract of Kappaphycus alverezii ( Eucheuma cottonii ). Cgn D is an alkali processed clarified iota carrageenan extract of Eucheuma denticulatum ( Eucheuma spinosum ) with low divalency. Both Cgn C and Cgn D have low divalency.

Table IV: Films Using Guar, Kappa Carrageenan, and Iota Carageenans

| INGREDIENT (G) | Ex 2-5 | Ex 2-6 | Ex 2-7 | Ex 2-2 |
|---|---|---|---|---|
| Water | 836.3 | 836.5 | 836.5 | 836.3 |
| Cgn C | 0 | 13.5 | 27 | 40.5 |
| Cgn D | 40.5 | 27 | 13.5 | 0 |
| GUAR | 49.5 | 49.5 | 49.5 | 49.5 |
| Starch B760 | 220.8 | 220.8 | 220.8 | 220.8 |
| SORBITOL SP | 264.4 | 264.4 | 264.4 | 264.4 |
| GLYCXERIN | 88.2 | 88.2 | 88.2 | 88.2 |
| Total weight | 1500.0 | 1500.0 | 1500.0 | 1500.0 |
| Temp, ° C.* | 93 | 90 | 90 | 90 |
| VISCOSITY, MPA-S* | 46,100 | 41250 | 41,500 | >50,000 |
| As Cast Film | | | | |
| Gel, ° C. | 70 | 46 | 43 | 53 |
| Melt, ° C. | 85-90 | 65-66 | 56-62 | 75-77 |
| pH | 5.8 | 5.4 | 5.4 | 5.2 |
| As Cast film | | | | |
| Solids, Brix | 39% | 43% | 41% | 40% |
| BF (g) | 102 | 48 | 95 | 227 g |
| Dried film (2 hrs @ 40C) | | | | |
| Solids, est | 63% | 60% | 60% | 65% |
| BF (g) | 1068 | 282 | 679 | 1574 |
| Dried film (16 hours, 40 C) | | | | |
| Solids, est | 82% | 80% | 80% | 85% |
| BF (g) | 5915 | 6097 | 5549 | 7638 |

* Temperature and viscosity of the molten mass prior to casting

The above examples show how the addition of the other carrageenans added strength to the low viscosity guar film. Further strengthening and control of gel/melt temperatures can be achieved by adding appropriate amounts of cations.

Example 3

Table V presents compositions and properties of films formed using mixtures of guar with potassium alginates and/or carrageenans. Alginates are polyuronate copolymers comprising mannuronate (M) and guluronate(G) units. KAHG is a potassium alginate where the alginate has a high level of G units and is extracted from Laminaria hyperborean . KAHM is a potassium alginate where the alginate has a high level of M units and is extracted from Lessonia trabeculata .

TABLE V: FILMS USING LOW VISCOSITY GUAR, POTASSIUM ALGINATES AND CARRAGEENANS

| INGREDIENTS (G) | Ex 3-1 | Ex 3-2 | Ex 3-3 |
|---|---|---|---|
| Water | 836.3 | 836.3 | 836.3 |
| KAHG | 60 | 60 | 40.5 |
| KAHM | 0 | 0 | 0 |
| Cgn L | 30 | 30 | 0 |
| GUAR ULV50 | 0 | 0 | 49.5 |
| Starch B760 | 220.8 | 220.8 | 220.8 |
| SORBITOL SP | 264.4 | 264.4 | 264.4 |
| GLYCERIN | 88.2 | 88.2 | 88.2 |
| Total weight | 1500.0 | 1500.0 | 1500.0 |
| Temp, ° C.* | 90 | 90 | 88 |
| VISCOSITY, MPAS* | 26,500 | 28,650 | 24,800 |
| Gel, ° C. | 42 | 41 | 50-51 |
| Melt, ° C. | 60-65 | 62-67 | 60-61 |
| pH | 7.6 | 7.2 | 6.3 |
| Cast Film | | | |
| Solids, est | 40% | 40% | 40% |
| BF (g) | <40 | <40 | <40 |
| Dried film (2 hrs @ 40° C.) | | | |
| Solids, est | 66% | 62% | 63% |
| BF (g) | 370 | 248 | 445 |
| Dried film (16 hours, 40 C) | | | |
| Solids, est | 81% | 79% | 85% |
| Avg film thickness (mm) | 0.83 | 0.76 | 0.56 |
| BF (g) | 3826 | 4253 | 4144 |
| | Ex 3-4 | Ex 3-5 | Ex 3-6 |
| Water | 836.3 | 836.3 | 836.3 |
| KAHG | 10.5 | 0 | 0 |
| KAHM | 0 | 60.0 | 10.5 |
| Cgn L | 30 | 30.0 | 30 |
| GUAR ULV50 | 49.5 | 0 | 49.5 |
| Starch B760 | 220.8 | 220.8 | 220.8 |
| SORBITOL SP | 264.4 | 264.4 | 264.4 |
| GLYCERIN | 88.2 | 88.2 | 88.2 |
| Total weight | 1500.0 | 1500.0 | 1500.0 |
| Temp, ° C.* | 90 | 93 | 92 |
| VISCOSITY, MPAS* | 28,250 | 42,650 | 31,250 |
| Gel, ° C. | 53 | 39 | 55 |
| Melt, ° C. | 70-74 | 60-63 | 65-69 |
| pH | 5.6 | 7.4 | 5.9 |
| Cast Film | | | |
| Solids, est | 40% | 38% | 41% |
| BF (g) | 188 | <40 | 185 |
| Dried film (2 hrs @ 40° C.) | | | |
| Solids, est | 64% | 62% | 66% |
| BF (g) | 1811 | 502 | 1265 |
| Dried film (16 hours, 40 C) | | | |
| Solids, est | 80% | 77% | 80% |
| Avg film thickness (mm) | 0.60 | 0.56 | 0.59 |
| BF (g) | 7960 | 6918 | 8301 |

* Temperature and viscosity of the molten mass prior to casting

Table VI reports compositions and properties of gel films prepared using blends of low viscosity guar ULV50 with sodium alginates. Protanal® LFR 5/60, Protanal® LF 20/40 and Protanal® SF 120 RB are sodium alginates available from FMC Corporation (Philadelphia, PA).

TABLE VI: FILMS USING GUAR AND ALGINATES

| Ingredient (g) | Ex 3-7 | Ex 3-8 | Ex 3-9 |
|---|---|---|---|
| WATER | 836.3 | 836.3 | 836.3 |
| LFR 5/60 | 40.5 | 0 | 0 |
| LF 20/40 | 0 | 40.5 | 0 |
| SF120 RB | 0 | 0 | 30 |
| GUAR ULV50 | 49.5 | 49.5 | 45 |
| Starch B760 | 220.8 | 220.8 | 220.8 |
| M100 | 0 | 0 | 15.0 |
| SORBITOL SP | 264.4 | 264.4 | 264.4 |
| GLYCERIN | 88.2 | 88.2 | 88.2 |
| Total weight | 1500.0 | 1500.0 | 1500.0 |
| Temp, ° C. | 90 | 94 | 93 |
| VISCOSITY, MPAS* | 31,650 | >50,000 | >50,000 |
| Gel, ° C. | 50 | NA | NA |
| Melt, ° C. | 70-71 | >95 | >93 |
| pH | 5.6 | 5.5 | 5.6 |
| Cast Film | | | |
| Solids, Brix | 40% | 40% | 40% |
| BF (g) | <40 | 102 | 110 |
| Dried film (2 hrs @ 40° C.) | | | |
| Solids, est | 60% | 64% | 67% |
| BF (g) | 617 | 1250 | 1126 |
| Dried film (16 hours, 40 C) | | | |
| Solids, est | 80% | 80% | 94% |
| Avg. film thickness (mm) | 0.53 | 0.89 | 0.51 |
| BF (g) | 4780 | 7701 | 10.850 |

* TEMPERATURE AND VISCOSITY OF THE MOLTEN MASS PRIOR TO CASTING

Table VII presents compositions and gel films formed from low viscosity guar ULV 50 in combination with propylene glycol alginate. Protanal® ester BV4830 and Protanal® ester SLF3 are propylene glycol alginates available from FMC Corporation (Philadelphia PA) and Kibun, respectively.

TABLE VII: FILMS USING LOW VISCOSITY GUAR AND PROPYLENE GLYCOL ALGINATE

| Ingredient | | | | | |
|---|---|---|---|---|---|
| (g) | Ex 3-10 | Ex 3-11 | Ex 3-12 | Ex 3-13 | Ex 3-14 |
| WATER | 836.5 | 840.3 | 840.3 | 840.3 | 836.5 |
| BV4830 | 12.0 | 0 | 91.2 | 0 | 12.0 |
| SLF-3 | 0 | 85.5 | 0 | 114 | 0 |
| HEC | 0 | 1.8 | 1.9 | 2.4 | 0 |
| Cgn L | 40.5 | 0 | 24 | 0 | 40.5 |
| Guar ULV50 | 37.5 | 30 | 0 | NONE | 37.5 |
| B760 | 220.8 | 207.8 | 207.8 | 207.8 | 220.8 |
| M-100 | 0 | 0 | 0 | 0 | |
| NA | 0 | 2.7 | 0 | 3.6 | |
| CITRATE | | | | | |
| K CITRATE | 0 | 0 | 2.9 | 0 | |
| KCL | 0 | 0 | 2.4 | 0 | |
| SORBIT- | 264.4 | 248.8 | 248.8 | 248.8 | 264.4 |
| OL SP | | | | | |
| GLYCERIN | 88.2 | 83.0 | 83.0 | 83 | 88.2 |
| Temp, ° C. | 90 | 87 | 90 | 91 | 90 |
| VISCOS- | 23,100 | 16,500 | 25,000 | 3250 | 23,100 |
| ITY, MPAS | | | | | |
| Gel, ° C. | 46 | 34-38 | 43-46 | 34-35 | 46 |
| Melt, ° C. | 60-68 | 62-64 | 56-62 | 58-60 | 60-68 |
| pH | 4.6 | 4.5 | 4.3 | 4.4 | 4.6 |
| Cast Film | | | | | |
| Solids, Brix | 41.5% | 41 | 45% | 39% | 41.5% |
| BF (g) | 147 | 40 | 231 | <40 | 147 |
| Dried film (2 | | | | | |
| hrs @ | | | | | |
| 40° C.) | | | | | |
| Solids, est | 60% | 65% | 55% | 74% | 60% |
| BF (g) | 592 | 355 | 842 | 1877 | 592 |
| Dried film | | | | | |
| (16 hours, | | | | | |
| 40C) | | | | | |
| Solids, est | 80% | 77% | 78% | 85% | 80% |
| Avg film | 0.62 | 0.60 | 0.75 | 0.67 | 0.62 |
| thickness | | | | | |
| (mm) | | | | | |
| BF (g) | 7214 | 3317 | 9599 | 4677 | 7214 |

EXAMPLE 4: FLUID MIXING APPARATUS OF FIGURE 3

The following examples show films made using the fluid mixing apparatus of Figure 3. In these examples, Part A and Part B were pumped from separate holding tanks at ambient temperature, as two separate streams 4, 6, into two different inlet ports 42, 44 which fed the steam injection fluid mixing apparatus device 10. The two individual streams 4, 6 were combined at the interface of the steam in the mixing zone 52 of the fluid mixing apparatus 10. The separate solutions of Part A and Part B were readily pumped into the fluid mixing apparatus 10 and mixed with steam 2. The steam 2 was introduced to the mixing zone at a pressure of 120 psi. The resulting molten mass or slurry mixture 8 flowed out of the exit port 56 of the fluid mixing apparatus 10. The mixture 8 was poured onto a smooth surface and drawn down to form a homogeneous film 9.

To measure the viscosity of the mixture 8, approximately 500 ml sample of the mixture 8 was collected from the outlet 56 and poured into a jar. The temperature, pH and viscosity were measured for this sample at 95ºC. A Brookfield LVF viscometer was used to measure the viscosity. An appropriate speed and spindle combination were used such that a reading could be taken. The dial reading was converted to dynamic viscosity (cP).

To measure the film strength and solids level, the molten mass 8 was collected from the outlet 56 then cast using a draw down bar, with a gap set at 3 mm, onto a stainless steel metal plate. The initial films 9 or "fresh films" were collected. Portions of the fresh films 9 were dried by placing them in a 40ºC forced air oven. Break force was measured on the cast and dried film strips using a Texture Analyzer TA-108S Mini Film Test Rig. The percent solids were determined by measuring the difference between the initial weight of the fresh film and the final weight of the dried films.

To measure the gel temperature, a portion of the molten mass 8 was collected from the outlet 56 of the mixing apparatus 10 and transferred to a test tube. Half of the test tube remained empty. A glass thermometer was inserted into the molten mass 8. The material 8 was allowed to cool under room temperature conditions. After each degree of cooling, the thermometer was removed from the material 8. When a small, temporary indentation was observed in the surface of the mass 8, this temperature was recorded. The thermometer was re-inserted into the mass 8, which was allowed to cool further. The thermometer was removed and re-inserted at every degree of cooling until such a time as a permanent indentation formed in the mass 8, such that the indentation did not refill. The temperature at which the permanent indentation formed was recorded. The gel temperature reported was the range between the two recorded temperatures.

Table VIII - Mixtures Containing LV Guar

| Example No. | 4-1 | 4-2 | 4-3 |
|---|---|---|---|
| Part A (%) | | | |
| Carrageenan 2 | 0 | 4.0 | 4.2 |
| Carrageenan 1 | 4.3 | 0.0 | 0.0 |
| ULV guar | 4.6 | 4.9 | 5.1 |
| Glycerin | 33.5 | 33.5 | 27.0 |
| Sorbitol | 0.0 | 0.0 | 8.1 |
| Part B (%) | | | |
| Starch | 20.7 | 20.7 | 21.8 |
| Water | 36.9 | | |
| Maixing chamber temp. (° C.) | 108 | 108 | 108 |
| Outlet temp (° C.) | 102 | 102 | 102 |
| Viscosity cP (@ 95° C.) | 7900 7800 | 69000 | |
| PH | 6.5 | 5.6 | 5.5 |
| % solids | 65 | 70 | 55 |
| Gel temp. (° C.) | 60-65 | 46 | >100 |
| wet film strength (grams) | 460 | 3402 | 921 |
| dry film strength (grams) | 5299 | 6587 | 9234 |

The following Tables IX and X provides further descriptions of the components specified in the above examples.

Table IX - Component Descriptions

| | | | |
|---|---|---|---|
| Name | Tarde Name | Supplier | Description |
| low viscosity | Edicol ULV50 | Indian Gum | |
| guar (LV guar) | | Industries, Ltd. | |
| Glycerin | | Callahan | 99.70% |
| | | Chemical | |
| Sorbitol | Sorbo | SPI Polyols | 70% sorbitol sol- |
| | | | ution, USP/FCC |
| Starch | Pure-Cote B790 | Grain Processing | |
| | | Corporation | |

The following Table X provides a description of the various carrageenans used in this example.

Table X - Carrageenan Descriptions

| | | | |
|---|---|---|---|
| | Carrageenan | | |
| Reference | Type | Description | Supplier |
| Carrageenan | Kappa | An alkali processed, clarified | FMC |
| 1 | | kappa-carrageenan extract of | |
| | | Kappaphycus alverazil | |
| | | (Euchauma cottonii) | |
| | | with low divalency | Corporation |
| Carrageenan | low divalent | An alkali processed, clari- | FMC |
| 2 | Kappa 2 | fied, low diversity extract | Corporation |
| | | of Gigartina skottsbargii, | |
| | | essentially haploid (gameto- | |
| | | phyte) plants, such extract | |
| | | being commonly known as | |
| | | “kappa-2 carrageenan”. | |
| | | Also includes minor levels | |
| | | (under 5% total) of lambda- | |
| | | and theta-carrageenans from | |
| | | diploid (tetrasporophyte) | |
| | | plants. Defined as the natural | |
| | | random block copolymer of | |
| | | kappa- and iota-carrageenans | |
| | | in the ratio of about 1.0 to | |
| | | 3.0:1 respectively, and has | |
| | | significantly different func- | |
| | | tionalities compared to mixing | |
| | | individual kappa- and iota- | |
| | | carrageenan natural polymers | |
| | | at the same ratio. | |

Example 5

Delivery films of the invention were prepared by the following method: Guar gum (Edicol ULV2-25, Indian Gum Industries, Ltd ) and kappa carrageenan were dry blended as a gum blend. Maltrin M 100 maltodextrin (Grain Processing Corp., Muscatine, Iowa) was dry blended with the gum blend. Deionized water and glycerin were weighed into a 1.2 liter stainless steel beaker. The dry premix was added to the water with good agitation, then heated to 90 ^{o} C and held within the temperature range 90 ^{o} C to 95 ^{o} C for 15 minutes to fully hydrate the gums. After replacing any water loss due to evaporation, the delivery ingredient was added and mixed two minutes for dispersion. The delivery ingredients tested were: (1) natural and artificial strawberry flavor (Dragoco, 0.1%), (2) titanium dioxide, and (3) caffeine. The hot solution was quickly poured into containers. Solution cast in petri dishes was cooled to room temperature to form films, then dried overnight in a forced draft oven at 45 ^{o} C to a constant weight. A sample was cooled then refrigerated (less than 8 ^{o} C) overnight prior to measurement of gel/melt properties and solids using an Atago E series hand held refractometer (Gardco, Pompano Beach, FL). The melt temperature was determined by placing a small chunk of the refrigerated gel on a wire string stand held within a test tube so that the chunk did not contact the wall of the test tube. The test tube was covered with aluminum foil with a small hole to allow measurement of the gel temperature using a digital tempermeter probe. The test tube was immersed in the heating bath so that the chunk is below the surface of a hot water bath at approximately 100 ^{o} C. A silicone oil bath was used for samples that had melt temperatures above 90 ^{o} C. The melt temperature was recorded when the gelled sample became wet in appearance, softened and could be stirred (a temperature range was noted). Once the sample had melted, the test tube was transferred to a second beaker containing cold tap water (15 ^{o} C). The temperature probe was used to record the temperature as the sample was cooled and to probe the sample surface to determine whether the sample had begun to gel. The gel temperature was the temperature upon cooling where the sample no longer flowed to fill in an indentation made by the probe. Break force (BF) and penetration were measured on the cast and dried film strips using a Texture Analyzer TA-108S Mini Film Test Rig. Rigidity was calculated as the BreakForce divided by the penetration.

Table XI: Low Viscosity Polymannan Delivery Systems

| Ingredient (g) | A | B | C |
|---|---|---|---|
| Kappa cgn | 1.25 | 1.25 | 1.25 |
| LV-50 Guar | 1.65 | 1.65 | 1.65 |
| Maltodextrin | 7.00 | 7.00 | 10.00 |
| Water | 80.0 | 80.00 | 80.00 |
| Glycerin | 6.7 | 6.7 | 6.70 |
| Flavor | 3.3 | 0.0 | 0.0 |
| TiO2 | 0.0 | 3.3 | 0.0 |
| Caffeine | 0.0 | 0.0 | 0.30 |
| As cast film | | | |
| Solids | ˜22% | ˜22% | ˜22% |
| Gel strength | 145 | 150 | 100 |
| Penetration | 1.3 | 1.0 | 1.3 |
| Rigidity | 112 | 153 | 74 |
| Dired film 16 hours @ 45° C. | | | |
| Solids | | | |
| Thickness, mm | | | |
| BF (g) | 3417 | 9827 | 6374 |
| Penetration, cm | 1.8 | 1.8 | 1.5 |

Example 6

Rapidly dissolving delivery films of the invention were prepared by the following method: guar gum (Edicol ULV2-25, Indian Gum Industries, Ltd ) and iota carrageenan were dry blended as a gum blend. Maltin M100 maltodextrin (Grain Processing, Muscatine, Iowa) or Clintose VF dextrose (ADM Corn Processing) was blended with Avicel® PH105 microcrystalline cellulose (FMC Corp, Philadelphia PA) then the gum mixture was added and dry blended to give a dry premix. Deionized water was weighed into a 1.2 liter stainless steel beaker. The dry premix was added to the water with good agitation, then heated to 90 ^{o} C and held within the temperature range 90 ^{o} C to 95 ^{o} C for 15 minutes to fully hydrate the gums. After replacing any water loss due to evaporation, the hot solution was deposited onto a carrier such as polyester film or a petri dish. Formulations A and C did not gel when initially cooled to room temperature while B and D formed a soft gel. The dextrose films air dried overnight at ambient conditions could be easily removed from the carrier. Films A and B were flexible but not fully dry. Films C and D were brittle but released from the carrier. All films dried in a forced air oven at 45 ^{o} C were rigid and brittle. Dissolution of the oven dried films was observed under a microscope by placing a small piece of the film in the visual field and adding a drop of water. The release of microcrystalline cellulose particles from the hydrating film was observed under polarized light. After a minute of hydration time, the sample was stained with methylene blue reagent and soluble carrageenan was observed. The properties of these delivery film composition are a function of the composition for example the dissolution rate is increased by decreasing the gum level and the film flexibility is increased by addition of a plasticizer such as glycerin.

.

Table XII: Fast Dissolving Delivery System

| | A | B | C | D |
|---|---|---|---|---|
| Guar LV 2-25 | 3% | 3% | 3% | 3% |
| Iota | 2% | 0 | 2% | 0 |
| (visc 10-35) | | | | |
| Iota | 0 | 2% | 0 | 2% |
| (visc 45-75) | | | | |
| PH-105 | 5% | 5% | 5% | 5% |
| Dextrose | 10% | 10% | 0 | 0 |
| Maltodextrin | 0 | 0 | 10% | 10% |
| Water | 80% | 80% | 80% | 80% |

Example 7

Additional fast dissolving polymannan gel films were prepared using 5% of a gum mixture, 5% AVICEL PH 105 microcrystalline cellulose, 10% dextrose and 80% distilled water. The iota carrageenan had a Brookfield viscosity of 30 to 50 cP and the viscosity of the kappa carrageenan is 10 to 15 cP when measured at 75 ^{o} C at 1.5% solids in an aqueous solution. The mixture was prepared as in example 6. The films were cast on a plate. The gel and melt temperature were obtained for films after refrigeration overnight. The dried films were slightly flexible after drying overnight at 45 ^{o} C and were observed to rapidly dissolve when a drop of water was placed on the film and observed under a microscope.

TABLE XIII: Fast Dissolving Polymannan formulations and properties

While the invention has been described in detail and with reference to specific embodiments thereof, it will be apparent to one skilled in the art that various changes and modifications can be made therein without departing from the spirit and scope thereof.

1. A delivery system comprising a homogeneous, thermoreversible gel film, wherein said gel film comprises: (i) a film forming amount of low viscosity guar gum and optionally at least one of a plasticizer, a second film former, a bulking agent, and a pH controlling agent; and (ii) an active substance.

2. The delivery system of claim 1, wherein said active substance is at least one of an oral care agent, a breath freshening agent, a pharmaceutical agent, a nutraceutical agent, a salivary stimulant agent, cosmetic ingredient, agricultural active, a vitamin, a mineral, a coloring agent, a sweetener, a flavorant, a fragrance or a food.

3. The delivery system of claim 1, wherein said guar gum is present in an amount of at least 0.25% by dry weight of the gel film.

4. The delivery system of claim 1, wherein said guar gum is present in an amount of 0.25% to 25% by dry weight of the gel film.

5. The delivery system of claim 1, wherein said guar gum is present in an amount of at least 10% of the total dry weight of film formers in the gel film.

6. The delivery system of claim 1, wherein said guar gum is present in an amount of at least 40% of the total dry weight of film formers in the gel film.

7. The delivery system of claim 1, wherein said guar gum is present in an amount of at least 60% of the total dry weight of film formers in the gel film.

8. The delivery system of claim 1, wherein said guar gum is present in an amount of at least 80% of the total dry weight of film formers in the gel film.

9. The delivery system of claim 1, wherein said guar gum is the only film former present in the gel film.

10. The delivery system of claim 1, wherein said second film former is selected from the group consisting of starch, starch derivative, starch hydrozylate, cellulose gums, kappa carrageenan, iota carrageenan, alginates, propylene glycol alginate, polymannan gums, pullulan, gellan, dextran, pectin, alkylcellulose ethers and modified alkyl cellulose ethers.

11. The delivery system of claim 1, wherein said plasticizer is at least one member selected from the group consisting of glycerin, sorbitol, maltitol, lactitol, corn starch, fructose, polydextrose, solubilized oil, and polyalkylene glycols; said second film former is at least one member selected from the group consisting of a starch, starch derivative, starch hydrozylate, cellulose gum, kappa carrageenan, iota carrageenan, alginates, propylene glycol alginate, polymannan gums, pullulan, gellan, dextran, pectin, an alkylcellulose ether and a modified alkyl cellulose ether; and said bulking agent is at least one member selected from the group consisting of microcrystalline cellulose, microcrystalline starch, starch, starch derivatives, inulin, and starch hydrozylates.

12. The delivery system of claim 1 having a break force strength of at least 2,500 grams.

13. The delivery system of claim 1 having a break force strength of at least 4,000 grams.

14. The delivery system of claim 1 having a break force strength of at least 5,000 grams.

15. The delivery system film of claim 1 having a break force strength of at least 6,000 grams.

16. A process for preparing the homogeneous gel film delivery system of claims 1-15 comprising the steps of:
(i)heating, hydrating, mixing, solubilizing, and, optionally, de-aerating said low viscosity guar and optionally at least one of a plasticizer, a second film former, a bulking agent, and a pH controlling agent in an apparatus providing sufficient shear, temperature and residence time to form a homogeneous molten composition, wherein said temperature is at or above the solubilizing temperature of said composition;
(ii)adding an effective amount of an active substance either prior to or after formation of the molten composition; and
(iii)cooling said molten composition containing said active substance at or below its gelling temperature to form said gel films containing said active substance.

17. The process of claim 16, wherein said active substance is at least one of an oral care agent, a breath freshening agent, a pharmaceutical agent, a nutraceutical agent, a salivary stimulant agent, a vitamin, a mineral, a cosmetic ingredient, an agricultural active, a coloring agent, a sweetener, a flavorant, a fragrance, a food.

18. The delivery system of claim 1 having a break force strength of at least 250 grams.

19. The delivery system of claim 1 having a break force strength of at least 1,000 grams.

20. A delivery system comprising a homogeneous, thermoreversible gel film, wherein said gel film comprises: (i) a film forming amount of low viscosity polymannan gum and optionally at least one of a plasticizer, a second film former, a bulking agent, and a pH controlling agent; and (ii) an active substance.

21. A process for preparing a homogeneous gel film delivery system comprising the steps of:
(i)heating, hydrating, mixing, solubilizing, and, optionally, de-aerating a low viscosity polymannan gum and optionally at least one of a plasticizer, a second film former, a bulking agent, and a pH controlling agent in an apparatus providing sufficient shear, temperature and residence time to form a homogeneous molten composition, wherein said temperature is at or above the solubilizing temperature of said composition;
(ii)adding an effective amount of an active substance either prior to or after formation of the molten composition; and
(iii)cooling said molten composition containing said active substance at or below its gelling temperature to form said gel films containing said active substance.

22. The delivery system of claim 1, wherein said gel film does not contain a plasticizer.

23. The delivery system of claim 1 consisting of said low viscosity guar gum, a bulking agent, an active substance and water.

24. The delivery system of claim 23, wherein said bulking agent is corn syrup.

25. The delivery system of claim 20, wherein said gel film does not contain a plasticizer.

26. The delivery system of claim 25 consisting of said low viscosity polymannan gum, a bulking agent, an active substance and water.

27. The delivery system of claim 26, wherein said bulking agent is corn syrup.
